(19) United States
(12) Patent Application Publication
(10) Pub. No.: US 2022/0005069 A1
(43) Pub. Date: Jan. 6, 2022

(54) USER ENGAGEMENT SYSTEM

(71) Applicant: Klixters, Inc., Cape Coral, FL (US)

(72) Inventors: Milo Seidl, North Fort Myers, FL (US); Aleksandr Gudilko, Calabasas, CA (US); Dmitry Pankul, Ivanovo (RU); Vitaly Pankov, Rostov-on-Don (RU)

(21) Appl. No.: 16/918,143

(22) Filed: Jul. 1, 2020

(51) Int. Cl. G06Q 30/02

(52) U.S. Cl. CPC G06Q 30/0245; G06Q 30/0212

(57) ABSTRACT

A user engagement system includes a network interface, a content storage device and a ticket activation module. The network interface allows users to connect to the user engagement system through a network. The content storage device stores content for user engagement. A ticket activation module, displays a ticket in a first state when a user is not eligible to participate in a daily drawing, and the ticket activation module displaying the ticket in a second state when the user completes an activation process and is eligible to participate in a daily drawing. An invitation module presents to the user an invitation webpage that allows the user to invite others to join the user engagement system. Additional users who join the user engagement system as a result of an invitation from the user are added to the user's profit sharing community.

### BACKGROUND

Interactive technologies create opportunities for users to communicate, to build community, to network, to create and communicate technological advances and to exchange information.

### BRIEF DESCRIPTION OF THE DRAWINGS

FIG. 1 shows a user engagement system that operates as a interactive technology that facilitates user interactive communication and the exchange of information.

FIG. 2 is a simplified chart illustrating overall operation of the user engagement system shown in FIG. 1.

FIG. 3 is a simplified chart illustrating operation of a coin match feature within the user engagement system shown in FIG. 1.

FIG. 4 is a simplified chart illustrating administration and use of the user engagement system shown in FIG. 1.

FIG. 5, FIG. 6, FIG. 7, FIG. 8, FIG. 9, FIG. 10, FIG. 11 and FIG. 12 show example web pages created by the user engagement system shown in FIG. 1.

### DETAILED DESCRIPTION

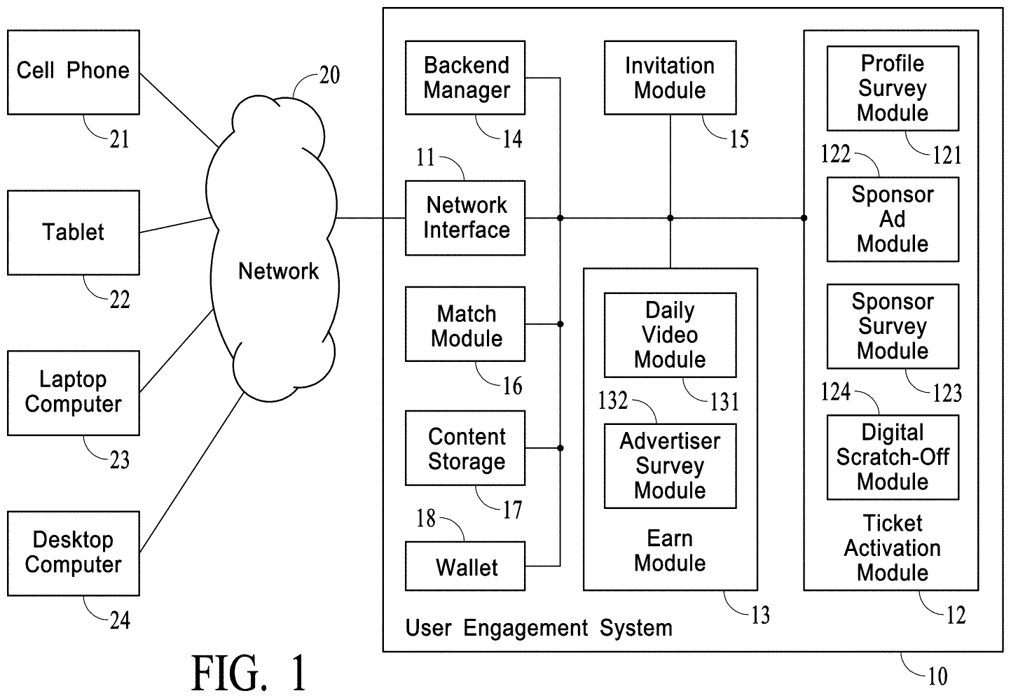

FIG. 1 shows a user engagement system 10 that includes a network interface 11 that allows users to connect to the user engagement system through a network 20. A content storage device 17 stores content for user engagement. A backend manager 14 allows an administrator to oversee information within content storage device 17.

A ticket activation module 12 displays a ticket in a first state when a user is not eligible to participate in a daily drawing. Ticket activation module 12 displays the ticket in a second state when the user completes an activation process and is eligible to participate in a daily drawing. For example, in the first state the ticket is grey and in the second state the ticket is gold.

Ticket activation module 12 includes a profile survey module 121 that presents survey questions to the user and records responses to the survey questions from the user. Ticket activation module 12 also includes a sponsor ad module 122 that presents the user with a sponsored video. Ticket activation module 12 also includes a sponsor survey module 123 that presents sponsor survey questions to the user and recording responses to the sponsor survey questions. Ticket activation module 12 additionally includes a digital scratch-off module 124 that awards to the user additional entries to the daily drawing. For example, the digital scratch-off module awards to the user additional entries to the daily drawing, the user engagement system displays to the user winners of the daily drawing.

For example, user engagement system 10 also includes an earn module 13 that presents to the user an opportunity to earn rewards points. For example, earn module 13 includes a daily video module 131 that allows the user to earn rewards points through watching and rating videos, and includes an advertiser survey module 132 that allows the user to earn reward points by completing advertiser surveys.

For example, user engagement system 10 also includes an invitation module 15 that presents to the user an invitation webpage that allows the user to invite others to join user engagement system 10. For example, additional users who join user engagement system 10 as a result from an invitation of the user are added to the user's profit sharing community. For example, the user is awarded a percentage of reward points earned by the additional users within the user's profit sharing community.

For example, user engagement system 10 also includes a match module 16 that awards to the user a percentage of reward points earned by the additional users within the user's profit sharing community. For example, a value of the percentage varies based on a current ranking of the user. For example, at a first level, the value of the percentage is two percent, at a second level, the value of the percentage is four percent, at a third level, the value of the percentage is six percent, at a fourth level, the value of the percentage is eight percent and at a fifth level, the value of the percentage is ten percent.

For example, user engagement system 10 also includes a wallet 18 that stores reward points. For example, the wallet allows the user to covert the reward points into U.S. dollars that can be transferred to the user.

Users and administrators interact with user engagement system 10, for example, via a computer implemented device such as a cell phone 21, a tablet computer 22, a laptop computer 23 or a desktop computer 24. As illustrated in FIG. 1, cell phone 21, tablet computer 22 laptop computer 23 and desktop computer 24 are connected through network 20 to network interface 11 of user engagement system 10. For example network 20 is a local area network, a wide area network, the Internet, a cell phone network or some other network or combination of networks that facilitate communication between user engagement system 10 and users utilizing cell phone 21, tablet computer 22, a laptop computer 23 or desktop computer 24.

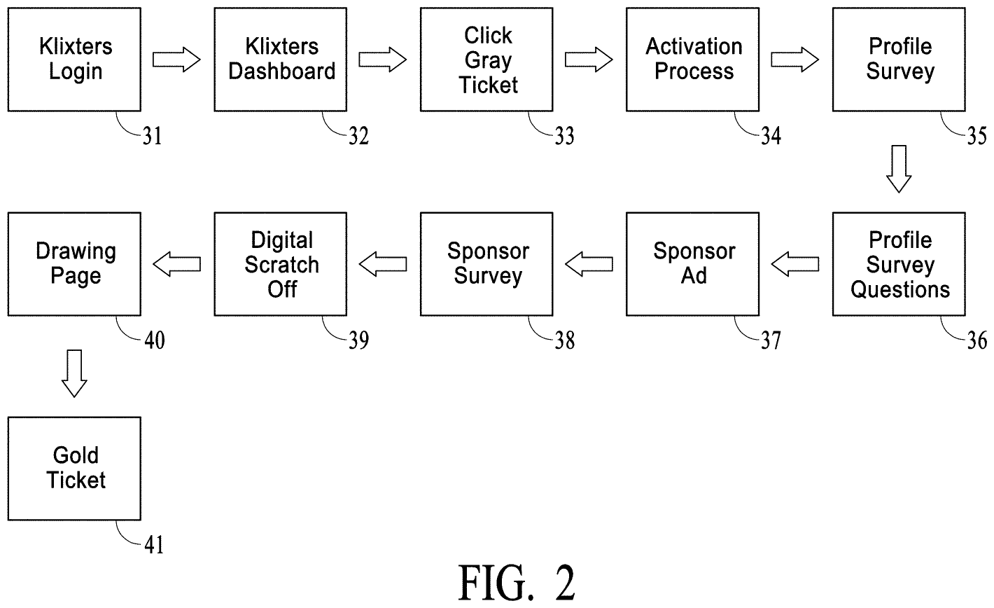

FIG. 2 is a simplified chart illustrating overall operation of user engagement system 10 to daily engage users. Users engage daily by logging in and participating in a daily drawing. User engagement system 10 engages users with a profile survey, a sponsor ad, and a sponsor survey. FIG. 6 shows an example web page that allows users to select activities to earn reward points.

For example, on a daily basis, a profile survey is conducted, an advertising video is shown, and an advertising survey is conducted. Once the above three engagements are completed, entries for a daily drawing are activated. Entries are earned from an initial invitation via a scratch off, inviting more people which earns more scratch offs and activating the daily drawing ticket daily, resulting in additional scratch offs. The entries in the daily drawing never expire. Alternatively, for example, when a member actually wins the daily drawing, their entries count resets to a lower number of entries, for example five entries. For example, the member might have one hundred eighty-five entries on the day they win the daily drawing so one hundred eighty-five entries resets to five entries for the next day. For example, a drawing is held every evening at a preselected time. The daily drawing provides motivation for users to log into user engagement system 10 daily.

For example, user engagement system 10 presents video ads to users where they can earn reward points for watching the ads. For example, the number of times an ad is watched by users can be limited based on the budget of the advertiser. For example, a progress bar associated with the ad encourages users to watch the ad and earn reward points before the ad budget disappears and they lose the opportunity to earn reward points.

For example, user engagement system 10 charges advertisers an engagement fee per user to watch their advertising videos and answer their advertising survey. For example the advertising budget for the ad campaign is based on the cost per engagement (CPE) and pay per engagement (PPE) the advertiser pays for an engage of a user watching advertising videos. For example, the amount of money in the ad campaign budget limits the number of users able to watch the advertising video and participate in the advertising survey. For example, for each video, a progress bar informs users how much of the ad campaign budget remains. For example, a 40% progress bar means 40% of the budget remains. Once the ad campaign budget is spent (zero budget remaining), no other users are able to engage with the advertiser.

For example, user engagement system 10 also allows users to earn a leveraged income based on a profit-sharing community (PSC) the users are able to build. For example, the user earns a percentage of all the reward points earned by members of the PSC built by the users. This encourages users to invite new users and build their PSC. For example, there is no limit to how many people a user can invite to user engagement system 10.

For example, reward points earned through members of a user's PSC are called bonus reward points. For example, bonus reward points pertain to Status, Rank, and Community. Status is personal reward points earned per month. For example, there are status levels. For example, an active level is achieved when the user earns one bonus reward point. For example, a platinum is achieved when a user earns three thousand bonus reward points earned. Rank is tier achievement and affects the percentage earned in the PSC that the user earns. For example, a one star rank for a user means the user will earn two percent of the reward points earned with the user's PSC. Similarly, a five star rank for a user means the user will earn ten percent of the reward points earned with the user's PSC, and so on. For example, for each user, their PSC is the downline which is infinite wide on level one and six levels deep. For example, status determines from whom in the PSC the user earns bonus reward points. For example, when a user achieves Platinum status, the user earns bonus reward points on all members within the user's PSC. For example and assuming a Platinum Status, 1-Star (2%) Rank, and 10K total reward points in their PSC, the bonus reward points for the user is calculated to be 200 bonus reward points. For example, if each bonus reward point is worth $0.01, then 200 bonus reward points would be equal to $2.00 earned by the user. For example, bonus reward points are calculated daily and paid out monthly.

For example, user engagement system 10 also has a scoring system for social advertising. The scoring system is similar to a credit score. The higher the profile score, the more accurately advertisers on user engagement system 10 can target areas of likely interest to the user. This is done, for example, by presenting a profile survey to a user each day before activating daily drawing entries for the user. Each profile survey has questions and the answers to these questions are the data points for the user's profile score. Over time, each user will be assigned a score. The more surveys a user conducts, the higher the score a user will receive. A profile score database allows advertisers to target the users they would like to engage with. For example, an advertiser may want to only engage with users who own dogs and are married with kids.

FIG. 2 illustrates logic flow for the daily engagement of a user with user engagement system 10. In a block 31, the user logs in to user engagement system 10. For example, user engagement system 10 allows users to login through a website accessible over the Internet.

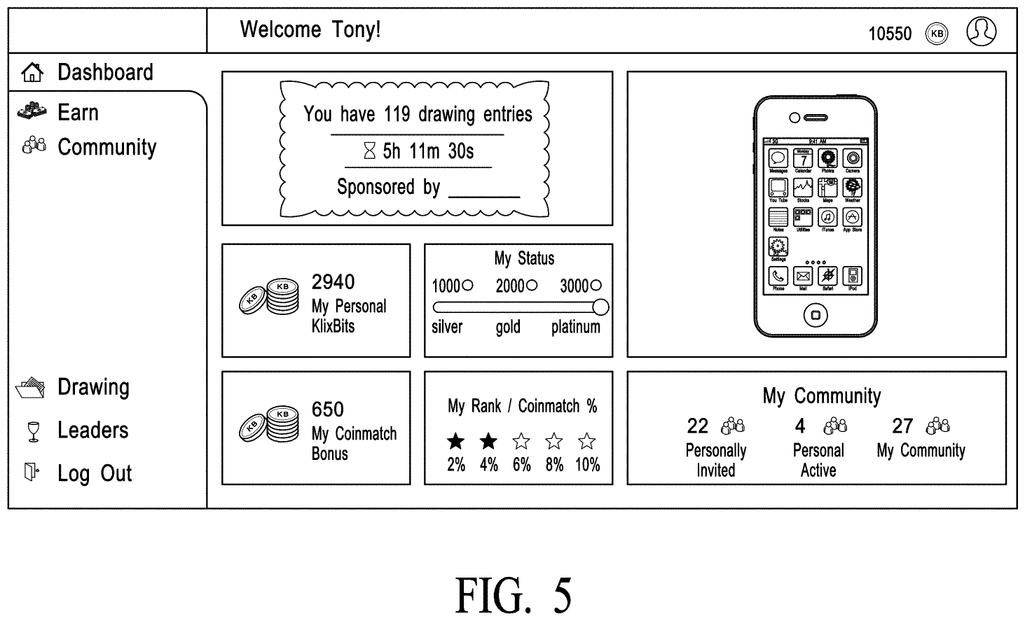

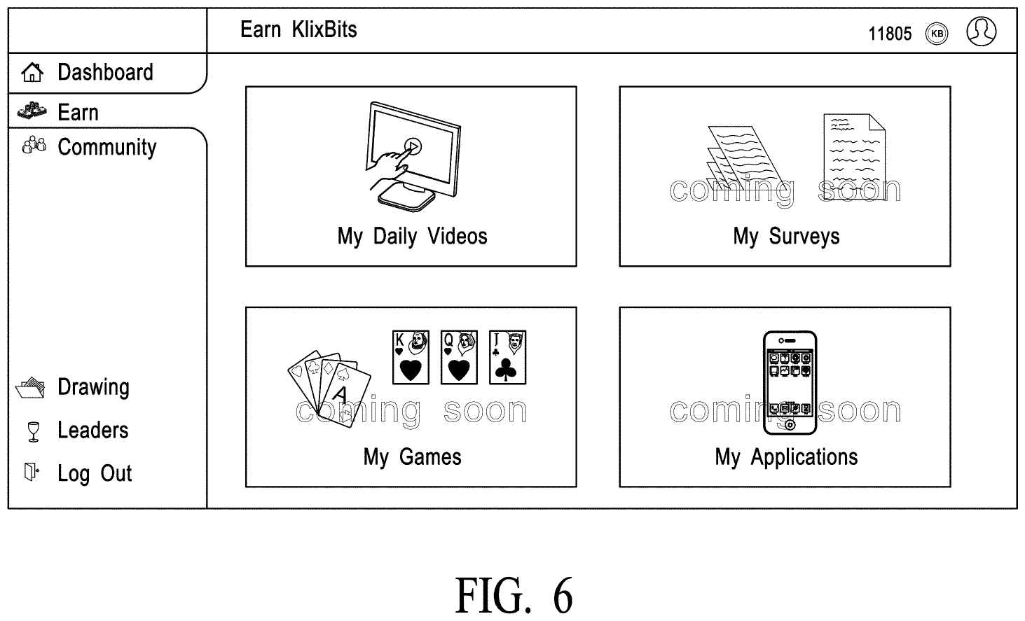

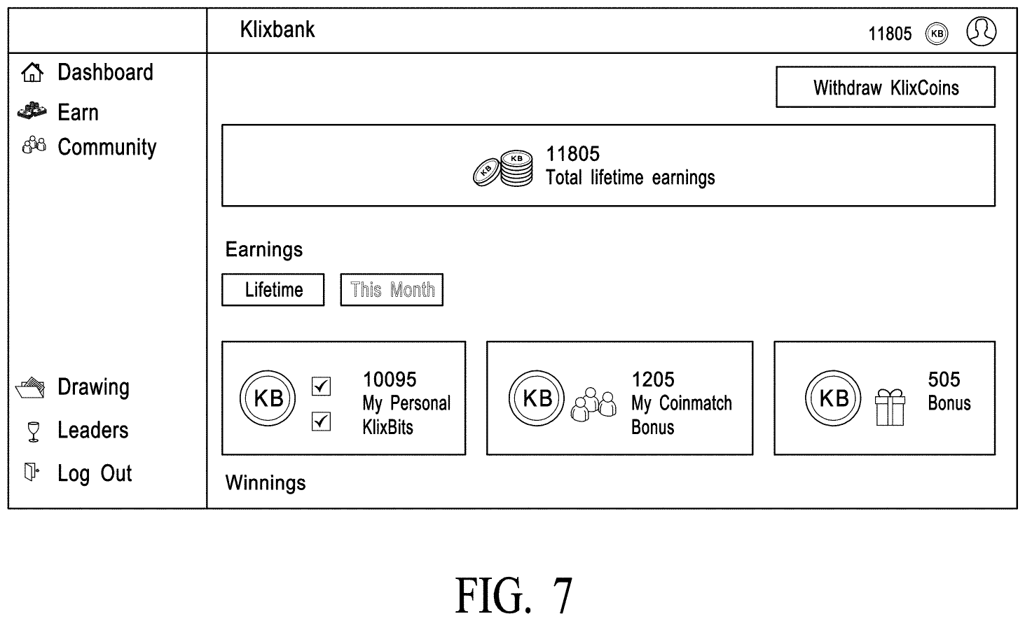

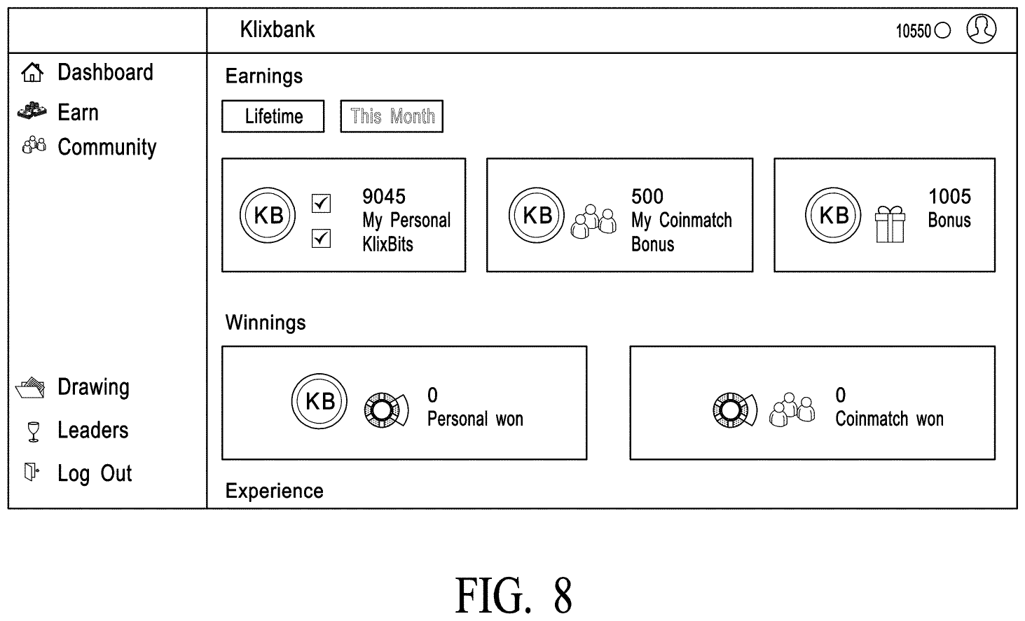

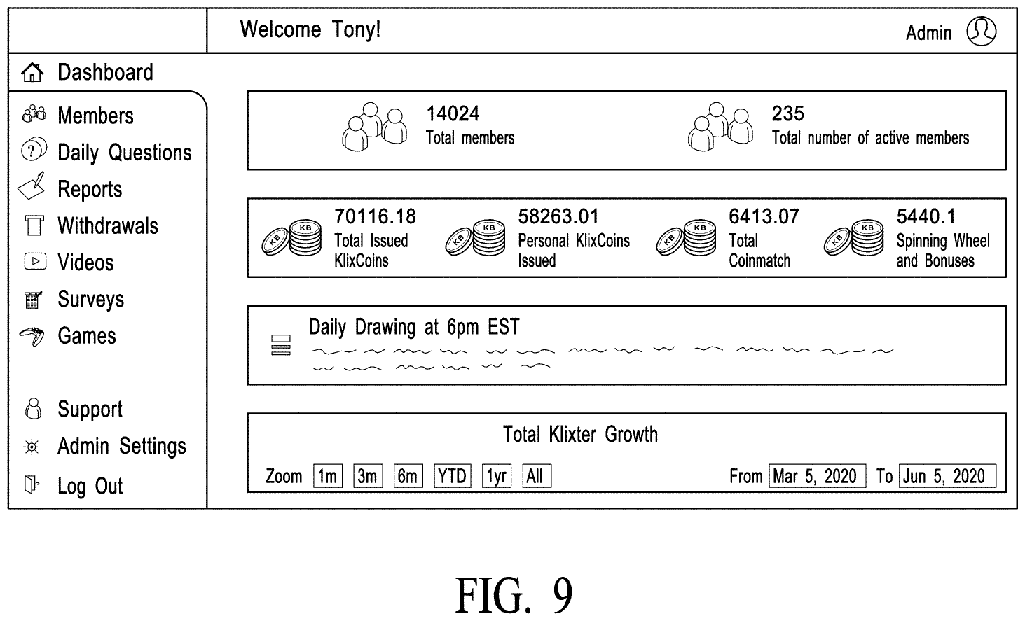

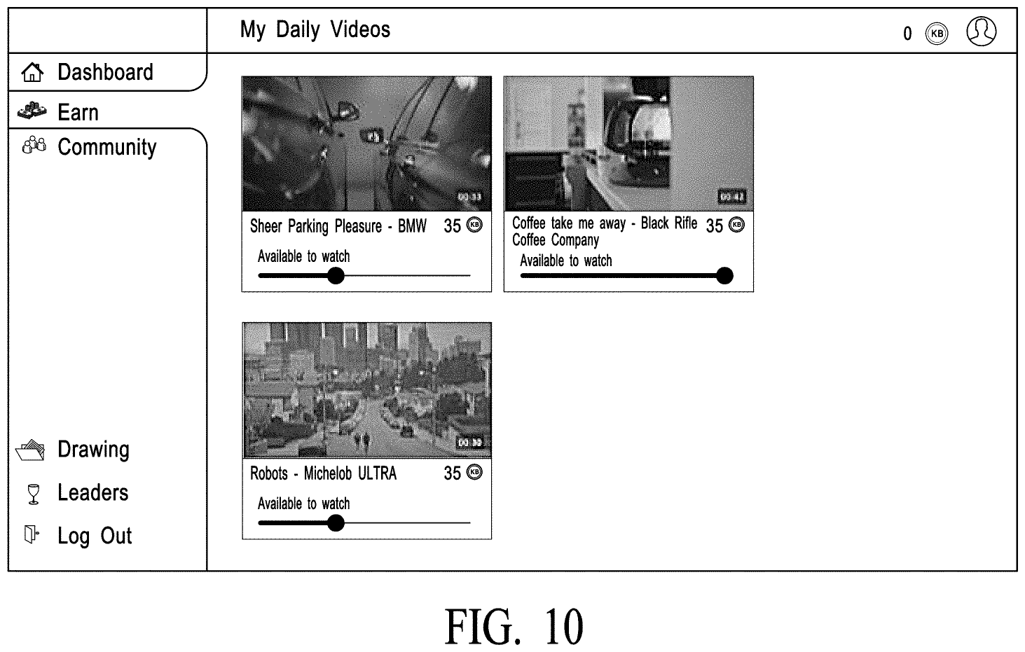

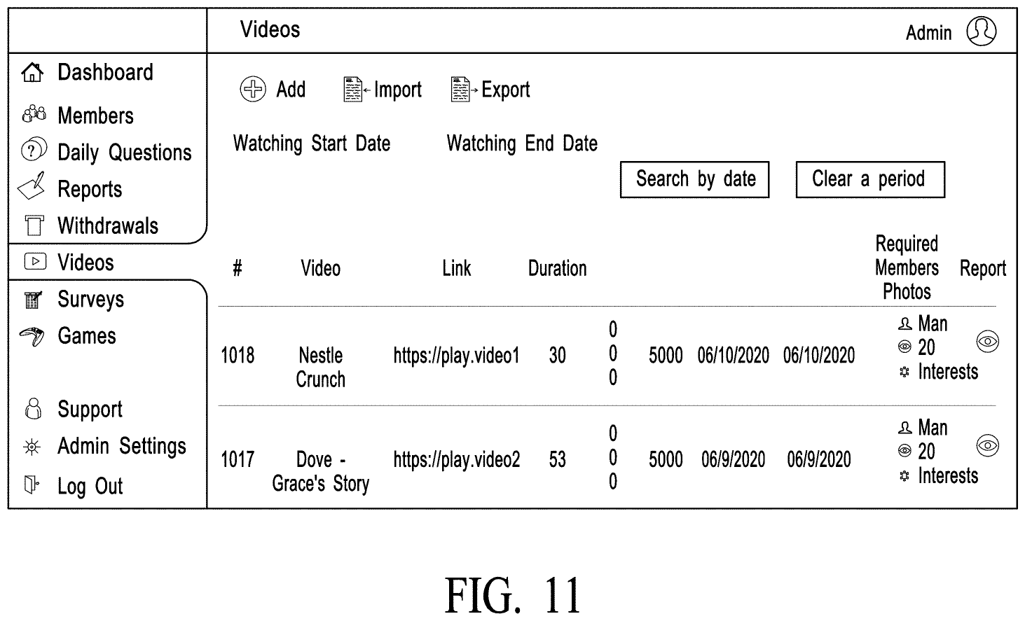

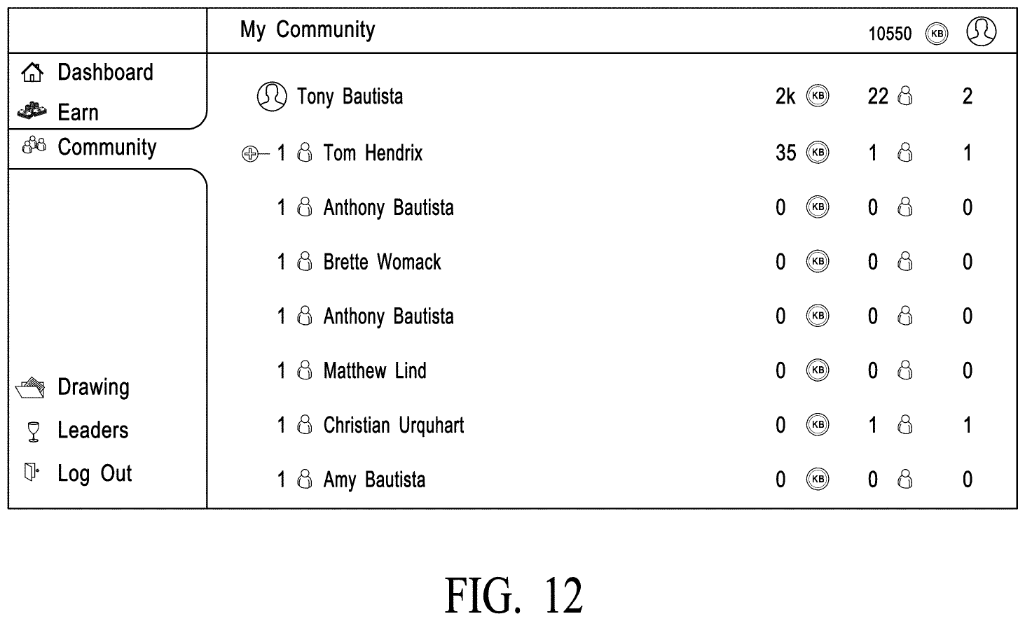

In a block 32, user engagement system 10 presents the user with a dashboard. For an example of a dashboard, see FIG. 5. In FIG. 5, reward points are called “KlixBits”.

In a block 32, from the dashboard, the user can select the digital image of a gray ticket. As represented in a block 33, after the user selects the gray ticket user engagement system 10 begins the activation process of the gray ticket. The purpose of activating the gray ticket is to allow the user to participate in the daily drawing to win reward points which can be exchanged for currency. For example, the daily drawing is conducted daily at a specific time such as at 6 pm Eastern Standard Time.

Block 35 represents the first step in the activation process where a profile survey is taken. The survey gathers data points about the user. Answers to the survey will dictate what type of questions will be asked going forward.

In a block 36, profile survey module 121 of user engagement system 10 presents the user with a series of profile survey questions. The profile survey questions presented to the user are retrieved from a database within user engagement system 10. Different surveys are presented to the user during the activation process. The answer to these questions are stored in the database within user engagement system 10.

In a block 37, after the profile survey, sponsor ad module 122 of user engagement system 10 presents the user a Daily Drawing sponsors commercial (video). In a block 38, after the user watches the sponsors commercial, sponsor survey module 123 of user engagement system 10 presents the user with the sponsors survey. The questions in the survey are intended to allow user engagement system 10 to gather market research data from the user. For example, the questions obtain information about current products the user owns or uses, and preferences the user has about particular products.

In a block 39, after the user completes the sponsors survey, digital scratch off module 124 of user engagement system 10 awards the user a digital scratch off. Scratching the digital scratch off reveals the number of additional entries the user wins. These additional entries are added to the existing entries for the user. This completes the activation process.

In a block 40, after the user scratches the digital scratch off and earns more entries into the Daily Drawing, user engagement system 10 takes the user to the Drawing page which shows all the winners of the Daily Drawing. In a block 40, after the user completes the activation process, user engagement system 10 turns the users gray ticket to gold, indicating the user now qualifies for the daily drawing.

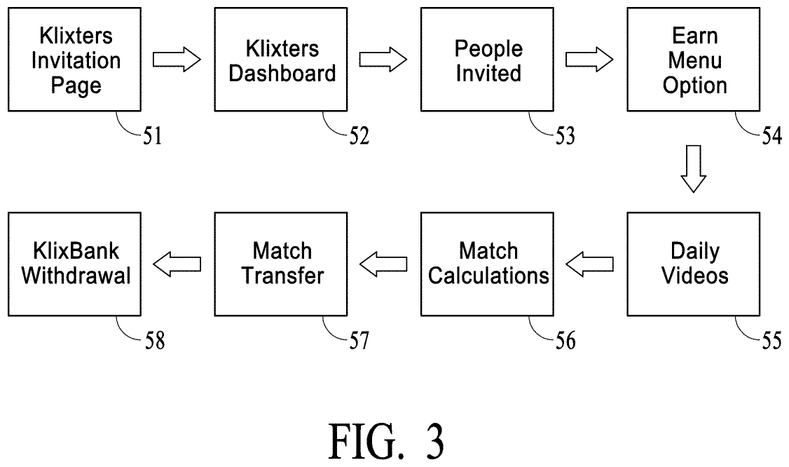

FIG. 3 illustrates logic flow for invitation module 15 of user engagement system 10 awarding bonus reward points to a user. In a block 51, a user goes to an invitation page to invite potential users to user engagement system 10 to become users of user engagement system 10. User engagement system 10 provides incentive to the user to invite as many people as they can so that the user can build their profit-sharing community (PSC). For example, FIG. 12 shows a web page where a user can track their profit-sharing community.

In a block 52, a new user logs into user engagement system 10 and enters the dashboard for user engagement system 10. In a block 53, when a current user of user engagement system 10 successfully invite people on to user engagement system 10, this allows the current user to achieve a higher rank in user engagement system 10. The higher the rank the greater the reward points for the user. For example, one invited person results in a one-Star rank. Ten invited people results in a two-Star rank, one hundred invited people equals a three-Star. When there are three three-Star members in a user's PSC, the user achieves a four-star rank. When there are three four-Star members in a user's PSC, the user achieves a five-star rank.

In a block 54, to earn reward points, a new user goes to the earn menu option in user engagement system 10. Through the Earn menu, earn module 13 of engagement system 10 allows users to earn reward points via watching videos, taking surveys, shopping at affiliated websites and so on. Users earn reward points to achieve a status. For example, earning one reward point earns an Active status. Earning one hundred reward points earns Bronze status. Earning one thousand reward points earns Silver status. Earning two thousand reward points earns Gold Status. Earning three thousand reward points earns Platinum status. The goal of the user is to achieve Platinum status on a monthly basis.

In a block 55, daily video module 131 of user engagement system 10 presents daily videos to the user allowing the user to earn reward points. After watching the video, advertise survey module 132 presents advertiser survey questions to the user. For example, the user earns ten reward points for watching and rating the video and the user earns twenty-five reward points for answering the advertisers survey questions. All members of the user's PSC do the same to earn reward points. FIG. 10 shows an example of a web page allowing a user to select daily videos to watch.

In some implementations, a spin wheel can be added to allow the user to win addition reward points by “spinning” the spin wheel after watching a daily video and taking an advertiser's survey.

In a block 56, user engagement system 10 calculates bonus reward points. For example, this is done in real time as the user earns bonus reward points. For example, based on the rank of the user, user engagement system 10 determines the amount of bonus reward points the user receives. For example, a user with a one-star ranking earns 2% of the total reward points in the user's PSC. A user with a two-star ranking earns 4% of the total reward points in the user's PSC. A user with a three-star ranking earns 6% of the total reward points in the user's PSC. A user with a four-star ranking earns 8% of the total reward points in the user's PSC. A user with a five-star ranking earns 10% of the total reward points in the user's PSC. For example, if the user is a two-star (4%) ranking and the user's PSC earns a total of 100 thousand reward points, the user earns a four thousand bonus reward.

In a block 57, on the first day of the month, user engagement system 10 moves the monthly bonus reward points for the user to a wallet 18 of the user.

In a block 58, the user can withdraw reward points from user engagement system 10. For example, one hundred reward points equals one USD. User engagement system 10 allows users to transfer the dollar equivalent of reward points from their wallet 18 to a pay service, such as Paypal. FIG. 7 shows a web page that can function as a “wallet” allowing users to track and withdraw their reward point earnings. FIG. 8 shows a web page that allows users to track their earning each month or over their lifetime involvement with user engagement system 10. In FIG. 7. and FIG. 8 reward points are referred to as “KlixBits” (KB).

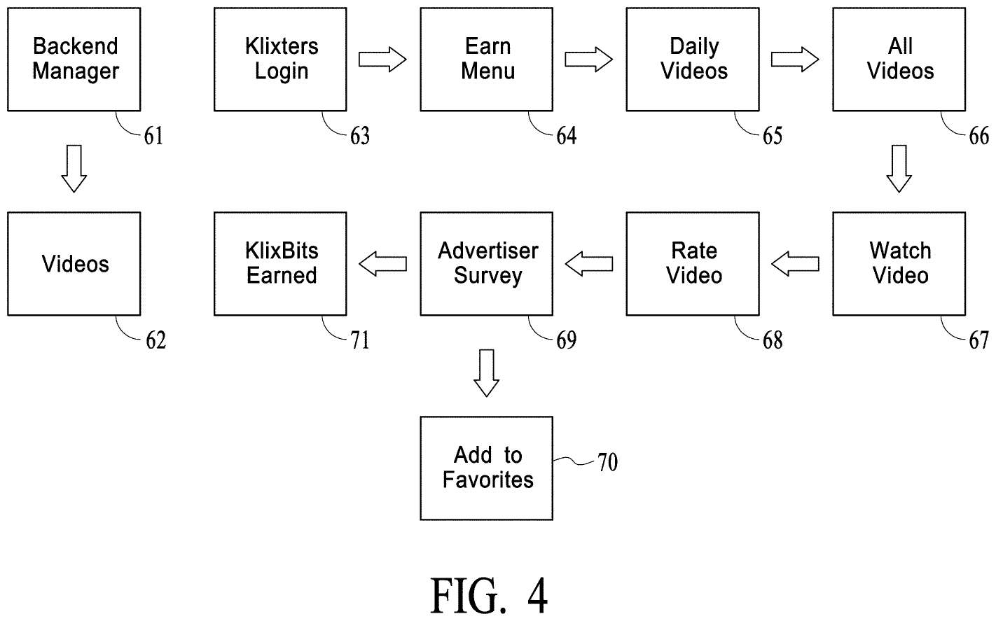

FIG. 4 illustrates process for a user to watch ad videos. In a block 61, user engagement system 10 allows an administrator to log in to a backend manager 14 of user engagement system 10. In a block 62, the administer creates a new advertising video which includes an advertiser's video advertisement and a survey. The purpose of the video is to engage users of user engagement system 10. The advertisers pay user engagement system 10 a pay per engagement (PPE) fee which is also a cost per engagement (CPE) fee.

In a block 63, a user logs into user engagement system 10 platform. In a block 64, the user selects an earn menu option within user engagement system 10 to earn reward points. In a block 65, after the user selects the earn menu, earn module 13 of user engagement system 10 presents the user with different ways to earn reward points by watching videos, taking surveys, shopping at affiliated websites, and so on. The user selects “Daily videos” to watch advertising commercials.

In a block 66, daily video module 131 user engagement system 10 presents the user with all the videos that are available to watch that day. In a block 67, the user clicks on the video the user wants to watch. User engagement system 10 has now engaged the user. The advertiser pays user engagement system 10 per user engagement.

In a block 68, after the user watches the video, the user rates the video. User engagement system 10 passes the rating back to advertiser. This data allows the advertiser to enhance or market test their videos.

In a block 69, after the user has rated the video, user engagement, advertiser survey module 132 of user engagement system 10 presents the user with the advertisers survey. The questions in the survey are market research data points the advertisers wants to collect from users of user engagement system 10 to enhance current products or develop new products.

In a block 70, user engagement system 10 allows the user the opportunity to save the videos to the user favorites to facilitate the user watching the video at a later time, shopping at the advertisers website, and/or to share the videos with friends and family. For example FIG. 11 shows a webpage that can be used to track videos that can be or have been watched.

In a block 71 user engagement system 10 awards the user reward points for watching the advertiser video.

FIG. 9 shows an administrator dashboard web page that tracks total members and active members. For example, reward points are also disclosed on the dashboard shown in FIG. 9.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A user engagement system, comprising:
a network interface that allows users to connect to the user engagement system through a network;
content storage device that stores content for user engagement; and
a ticket activation module, the ticket activation module displaying a ticket in a first state when a user is not eligible to participate in a daily drawing, and the ticket activation module displaying the ticket in a second state when the user completes an activation process and is eligible to participate in a daily drawing, the activation module including:
a profile survey module, the profile survey module presenting survey questions to the user and recording responses to the survey questions from the user,
a sponsor ad module, the sponsor ad module presenting the user with a sponsored video,
a sponsor survey module, the sponsor survey module presenting sponsor survey questions to the user and recording responses to the sponsor survey questions, and
a digital scratch-off module that awards to the user additional entries to the daily drawing.

2. A user engagement system as in claim 1, wherein after the digital scratch-off module awards to the user additional entries to the daily drawing, the user engagement system displays to the user winners of the daily drawing.

3. A user engagement system as in claim 1, wherein in the first state the ticket is grey and in the second state the ticket is gold.

4. A user engagement system as in claim 1, additionally comprising an earn module, the earn module presenting to the user an opportunity to earn rewards points, the earn module including:
a daily video module that allows the user to earn rewards points through watching and rating videos, and
an advertiser survey module that allows the user to earn reward points by completing advertiser surveys.

5. A user engagement system as in claim 1, additionally comprising an invitation module, the invitation module presenting to the user an invitation webpage that allows the user to invite others to join the user engagement system, wherein additional users who join the user engagement system as a result from an invitation of the user are added to the user's profit sharing community.

6. A user engagement system as in claim 1, additionally comprising an invitation module, the invitation module presenting to the user an invitation webpage that allows the user to invite others to join the user engagement system, wherein additional users who join the user engagement system as a result of an invitation from the user are added to the user's profit sharing community;
wherein the user is awarded a percentage of reward points earned by the additional users within the user's profit sharing community.

7. A user engagement system as in claim 1, additionally comprising:
an invitation module, the invitation module presenting to the user an invitation webpage that allows the user to invite others to join the user engagement system, wherein additional users who join the user engagement system as a result of an invitation from the user are added to the user's profit sharing community; and
a match module, the match module awarding to the user a percentage of reward points earned by the additional users within the user's profit sharing community, wherein a value of the percentage varies based on a current ranking of the user.

8. A user engagement system as in claim 1, additionally comprising:
an invitation module, the invitation module presenting to the user an invitation webpage that allows the user to invite others to join the user engagement system, wherein additional users who join the user engagement system as a result of an invitation from the user are added to the user's profit sharing community; and
a match module, the match module awarding to the user a percentage of reward points earned by the additional users within the user's profit sharing community, wherein a value of the percentage varies based on a current ranking of the user;
wherein at a first level, the value of the percentage is two percent;
wherein at a second level, the value of the percentage is four percent;
wherein at a third level, the value of the percentage is six percent;
wherein at a fourth level, the value of the percentage is eight percent; and
wherein at a fifth level, the value of the percentage is ten percent.

9. A user engagement system as in claim 1, additionally comprising:
an invitation module, the invitation module presenting to the user an invitation webpage that allows the user to invite others to join the user engagement system, wherein additional users who join the user engagement system as a result of an invitation from the user are added to the user's profit sharing community, wherein the user is awarded a percentage of reward points earned by the additional users within the user's profit sharing community; and,
a wallet that stores reward points, the wallet allowing the user to covert the reward points into U.S. dollars that can be transferred to the user.

10. A user engagement system as in claim 1, additionally comprising:
an earn module, the earn module presenting to the user an opportunity to earn rewards points, the earn module including:
a daily video module that allows the user to earn rewards points through watching and rating videos, and
an advertiser survey module that allows the user to earn reward points by completing advertiser surveys; and,
a wallet that stores reward points, the wallet allowing the user to covert the reward points into U.S. dollars that can be transferred to the user.

11. A user engagement system, comprising:
a network interface that allows users to connect to the user engagement system through a network;
a content storage device that stores content for user engagement;
an invitation module, the invitation module presenting to the user an invitation webpage that allows the user to invite others to join the user engagement system, wherein additional users who join the user engagement system as a result of an invitation from the user are added to the user's profit sharing community; and
a match module, the match module awarding to the user a percentage of reward points earned by the additional users within the user's profit sharing community, wherein a value of the percentage varies based on a current ranking of the user.

12. A user engagement system as in claim 11:
wherein at a first level, the value of the percentage is two percent;
wherein at a second level, the value of the percentage is four percent;
wherein at a third level, the value of the percentage is six percent;
wherein at a fourth level, the value of the percentage is eight percent; and
wherein at a fifth level, the value of the percentage is ten percent.

13. A user engagement system as in claim 11, additionally comprising:
a wallet that stores reward points, the wallet allowing the user to covert the reward points into U.S. dollars that can be transferred to the user.

14. A user engagement system as in claim 11, additionally comprising an earn module, the earn module presenting to the user an opportunity to earn rewards points, the earn module including:
a daily video module that allows the user to earn rewards points through watching and rating videos; and
an advertiser survey module that allows the user to earn reward points by completing advertiser surveys.

15. A user engagement system as in claim 11, additionally comprising:
an earn module, the earn module presenting to the user an opportunity to earn rewards points, the earn module including:
a daily video module that allows the user to earn rewards points through watching and rating videos, and
an advertiser survey module that allows the user to earn reward points by completing advertiser surveys; and,
a wallet that stores reward points, the wallet allowing the user to covert the reward points into U.S. dollars that can be transferred to the user.

16. A user engagement system, comprising:
a network interface that allows users to connect to the user engagement system through a network;
a content storage device that stores content for user engagement; and
an earn module, the earn module presenting to the user an opportunity to earn rewards points, the earn module including:
a daily video module that allows the user to earn rewards points through watching and rating videos, and
an advertiser survey module that allows the user to earn reward points by completing advertiser surveys.

17. A user engagement system as in claim 16, additionally comprising an invitation module, the invitation module presenting to the user an invitation webpage that allows the user to invite others to join the user engagement system, wherein additional users who join the user engagement system as a result from an invitation of the user are added to the user's profit sharing community.

18. A user engagement system as in claim 16, additionally comprising an invitation module, the invitation module presenting to the user an invitation webpage that allows the user to invite others to join the user engagement system, wherein additional users who join the user engagement system as a result of an invitation from the user are added to the user's profit sharing community;
wherein the user is awarded a percentage of reward points earned by the additional users within the user's profit sharing community.

19. A user engagement system as in claim 16, additionally comprising:
an invitation module, the invitation module presenting to the user an invitation webpage that allows the user to invite others to join the user engagement system, wherein additional users who join the user engagement system as a result of an invitation from the user are added to the user's profit sharing community; and
a match module, the match module awarding to the user a percentage of reward points earned by the additional users within the user's profit sharing community, wherein a value of the percentage varies based on a current ranking of the user.

20. A user engagement system as in claim 16, additionally comprising:
an invitation module, the invitation module presenting to the user an invitation webpage that allows the user to invite others to join the user engagement system, wherein additional users who join the user engagement system as a result of an invitation from the user are added to the user's profit sharing community, wherein the user is awarded a percentage of reward points earned by the additional users within the user's profit sharing community; and,
a wallet that stores reward points, the wallet allowing the user to covert the reward points into U.S. dollars that can be transferred to the user.
